(19) United States
(12) Patent Application Publication
(10) Pub. No.: US 2008/0089513 A1
(43) Pub. Date: Apr. 17, 2008

(54) Methods and devices for detection, control and annunciation of speakerphone use

(75) Inventors: Michael D. Kotzin, Buffalo Grove, IL (US); William P. Alberth, Prairie Grove, IL (US); Armin W. Klomsdorf, Libertyville, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/549,662

(22) Filed: Oct. 16, 2006

(51) Int. Cl. H04M 1/00

(52) U.S. Cl. 379/420.01

(57) ABSTRACT

Disclosed are methods and devices for remote determination, control and/or inhibiting the use of a speakerphone of a far end communication device. The methods and devices provide the ability to determine speakerphone use and provide remote control of a far end device's speakerphone, including prompting whether to disable the speakerphone of the far end device if determined to be active. Additionally disclosed are methods and devices of a first communication device having a speakerphone including engaging in a communication with a second communication device, determining if the speakerphone of the first communication device is active, and broadcasting that the speakerphone of the first communication device is active. Also disclosed are methods and devices a first communication device including determining an identity of an auditor at a second communication device and indicating at the first communication device the identity of an auditor at the second communication device.

### FIELD

Disclosed are methods and communication devices for monitoring speakerphone use, and more particularly for detection and control of remote speakerphone use, and annunciation of local speakerphone use.

### BACKGROUND

Mobile communication devices are very popular. According to the Cellular Telecommunications Industry Association (CTIA), at the end of 2005, over 200 million people in the United States alone use mobile telephones. PDAs, portable gaming devices, and other personal electronic devices are also popular and may provide communication capability.

Many mobile communication devices have speakerphone capability. Accordingly, speakerphones of mobile communication devices have privacy implications due to their mobility and since the number of mobile communication devices is so high. Speakerphones allow individuals proximal to the far end telephone to hear what is said by the speaker. However, the speaker may not wish to be heard by anyone else other than to whom he is speaking. Furthermore, when a speakerphone is enabled, it is capable of distant voice pickup and thus the device can pick up the conversation of proximal individuals, again without their knowledge.

Many mobile communication devices also have mute button capability. When a speakerphone is operational, a mute button controlled by the user of the speakerphone device may limit conversation from being overheard and from overhearing a proximal conversation. However, the far end device user cannot determine whether a speakerphone is in use and is not given an opportunity to control the speakerphone.

### BRIEF DESCRIPTION OF THE DRAWINGS

FIG. 1 shows embodiments of a first mobile communication device and a second mobile communication device;

FIG. 2 is a flow diagram representing a plurality of operations in accordance with this discussion; and

FIG. 3 is a signal flow diagram of an embodiment of the methods and devices as described below.

### DETAILED DESCRIPTION

Disclosed are methods and devices for remote determination, control and/or inhibiting the use of a speakerphone of a far end communication device. The methods and devices provide the ability to determine speakerphone use, provide remote control of a far end device's speakerphone, provide the ability to broadcast speakerphone use, as well as determining the identity of users. According, a far end device user can have an opportunity to learn whether a speakerphone is in use and to control a far end speakerphone.

More particularly, disclosed are methods and devices of a first communication device for determining at the first communication device if a speakerphone of a second communication device is active and alerting a user of the first communication device if a speakerphone of the second communication device is determined to be active. Also disclosed are methods and devices of a first communication device to determine if a speakerphone of the second communication device is active and prompting a user of the first communication device, if a speakerphone of the second communication device is determined to be active, whether to disable the speakerphone. Additionally disclosed are methods and devices of a first communication device having a speakerphone including engaging in a communication with a second communication device, determining if the speakerphone of the first communication device is active, and broadcasting that the speakerphone of the first communication device is active. Moreover, disclosed are methods and devices a first communication device including determining an identity of an auditor at a second communication device and indicating at the first communication device the identity of an auditor at the second communication device.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

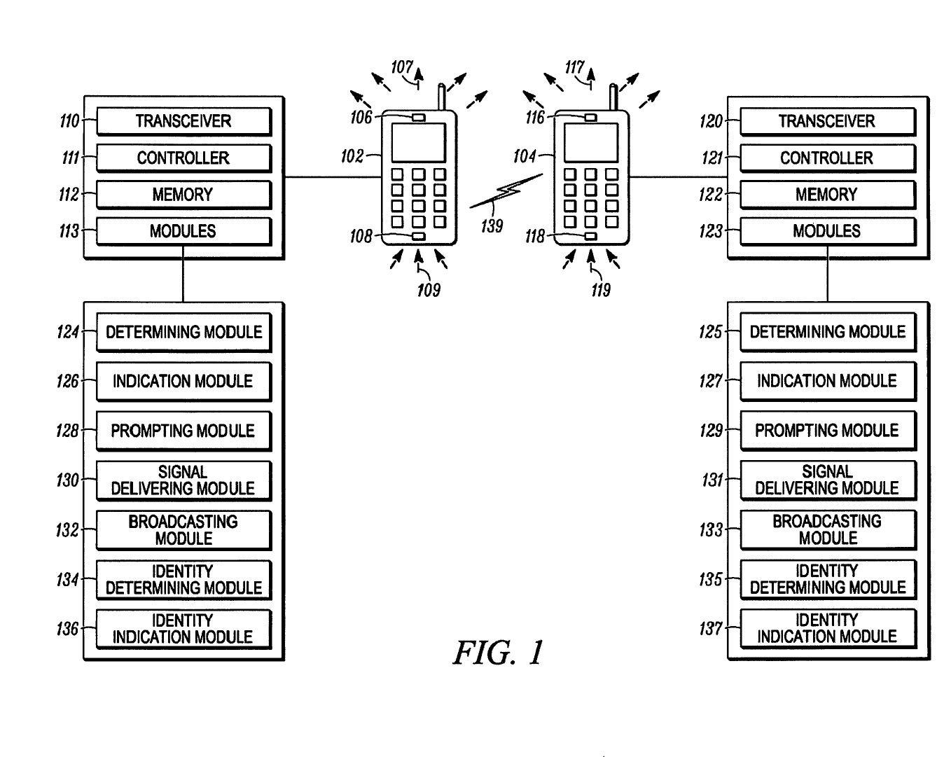

FIG. 1 shows a first mobile communication device 102 and a second mobile communication device 104. More than two communication devices can partake in a communication that is described in detail below. The mobile communication device 102 may be implemented as a cellular telephone (also called a mobile phone). The communication device 104 may be a mobile or a landline telephone. It is understood that the roles of the first and second communication devices are for convenience of illustration and may be assumed in the opposite or another manner.

The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP). Wired devices may also be depicted in FIG. 1.

The communication devices may communicate via a remote server within a wireless or wired communication network, or may be device-to-device for example, using a protocol such as Bluetooth. A network of course may be any type of wireless or wired network including an ad hoc or wireless personal area network, a WiFi or wireless local area network, and a cellular or wireless wide area network. Likewise, the server may be of any suitable configuration. The server may be implemented as a single server or as a plurality of servers in communication in any arrangement. The operations of the server may be distributed among different servers or devices that may communicate in any manner. It is understood that signals sent between devices and relating to the speakerphone determination and remote control may be relayed by a network in any manner.

The two devices depicted in FIG. 1 are mobile communication device 102 and 104. Each device, or one device, may include a speakerphone capability. For example, device 102 can include a transducer 106 that is configured to operate close to a user's ear, and/or operate as a speakerphone, indicated by the broadcast arrows 107. The output of the speakerphone transducer 106 may broadcast speech as well as other audible sounds, such as a chirp or a beep. Furthermore, each device, or one device, may include a speakerphone microphone 108 that is configured with a distant voice pick up to receive sounds including speech indicated by arrows 109. Corresponding broadcast arrows 117 and speech 119 are indicated for device 104.

Device 102 can include a one or more transceivers 110, a controller 111, memory 112, and modules 113. Similarly, device 104 can include a transducer 116, a microphone 118, one or more transceivers 120, a controller 121, memory 122, and modules 123. The modules 113 and 123 may include instructions that may be carried out by the respective controllers 111 and 121, such as determining modules 124 and 125, indication modules 126 and 127, prompting modules 128 and 129, signal delivering modules 130 and 131, broadcasting modules 132 and 133, identity determining modules 134 and 135, and identity indication modules 135 and 137. For simplicity of the discussion below, the modules of device 102 will be used by way of example. It is understood that the discussion is applicable to any other devices as well.

The modules can carry out certain processes of the methods as described herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

The communication arrow 139 indicates communication between devices 102 and 104. As mentioned above, one or more servers may process the communication or the communication may be device-to-device. The communication arrow 139 is intended to represent one or more signals passed between two or more devices relating to a communication engagement. The communication may be carried over wireless, wired, or a combination of wireless and wired means.

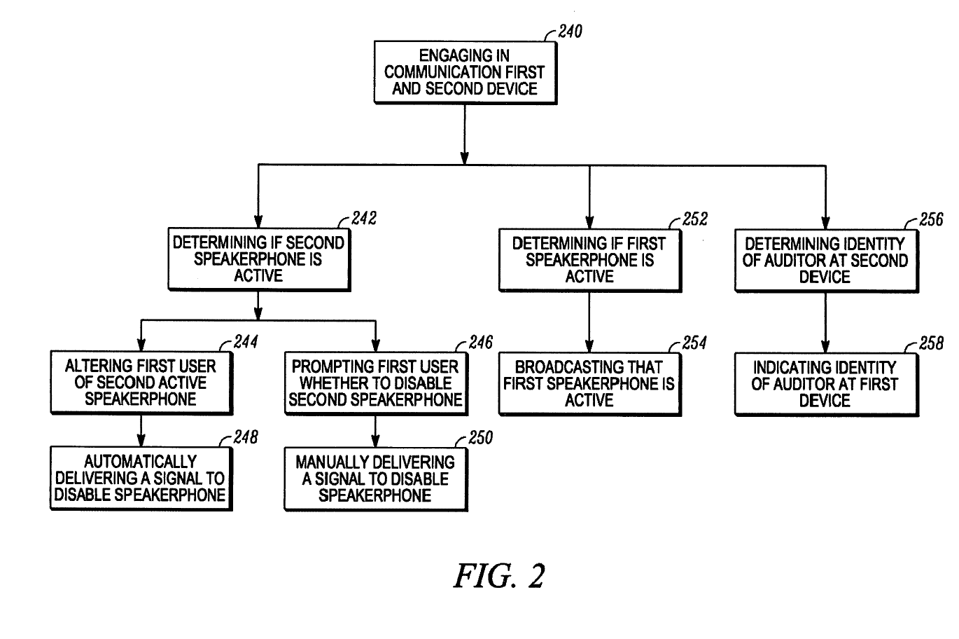

FIG. 2 is a flow diagram representing a plurality of operations in accordance with this discussion. Upon or during engagement in communication 240, signals between two or more devices 102 and 104 (see FIG. 1) may be received by their respective transceivers 110 and 120, and processed by the respective controllers 111 and 121 according to instructions stored in memory 112 and 122 or otherwise received, and responsive signals may be transmitted by their respective transceivers 110 and 120. Upon or during engagement a device 102 or 104 could inform the other device that the speakerphone is active and/or in the state of mute. The information could pass over any suitable communication channel such as, for instance, a cdma2000 short data burst between the two devices, where the message is understood by both phones to indicate the state of the speakerphone or mute control

In one embodiment shown in the flowchart of FIG. 2, the first communication device 102 (see FIG. 1) can determine if a speakerphone 116 of the second communication device 104 is active 242 in accordance with determining module 124. The determination can be made on a demand basis or on a periodic or persistent basis. If the speakerphone 116 of the second device 104 is active, the first device 102 can alert a user of the first communication device 244 in accordance with indication module 126. In another embodiment, if it is determined that the speakerphone 116 of the second device 104 is active 242, a user of the first communication device 102 may be prompted as to whether to disable the speakerphone 246 in accordance with prompting module 128.

The annunciation of the alert 244 and/or the prompt 246 can be made in any manner including for example, indicia on a display screen of the device 102 (see FIG. 1), or audibly as output of the speaker. Input to respond to the prompt can be made in any manner including via the keypad of the device 102 or orally by a speech recognition application. Where the user is alerted 244 and/or prompted 246, the user of device 102 can deliver a signal to the second device 104 to inactivate the speakerphone 248 and 250 in accordance with module 130. Accordingly, a user of device 102 when in communication with a remote device 104 can determine whether a speakerphone is in use and can control and thus inactivate the speakerphone. In this manner, a speaker at the first device 102 may avoid individuals proximal to a far end telephone, that is, the remote second device 104, hearing what is said by the speaker of the first device 102.

In another embodiment, in determining if a speakerphone 106 (see FIG. 1) of the first communication device 102 is active 252, a signal can be broadcast that the speakerphone 106 is active in accordance with broadcast module 132. In one embodiment, broadcasting can include emitting a characteristic audible signal through the speakerphone 106. The speaker system 106 of the device 102 can make an unobtrusive but discernable noise. Accordingly, an audible sound indication 107 (see FIG. 1) from the speakerphone 106 transducer at the first device 102 or any like device, can provide an indication to those persons proximal the device 102 that a speakerphone is active. Accordingly, proximal individuals may limit their conversation or move to another location to avoid the distant voice pick up of the speakerphone microphone 108 of device 102.

In one embodiment, the broadcasting can include signaling nearby devices via transceiver 110 (see FIG. 1) that a speakerphone within a predetermined range is active. For example, the broadcasting device 102 may send an ultrasonic or Bluetooth beacon or signal to proximal devices to the speakerphone 106. Other devices may sense the beacon and provide a secondary indication to the devices' users such as a visual or aural indication that there is a nearby speakerphone activation. In this way, a user of another device may be warned that his or her conversation might be picked up by the speakerphone.

In another embodiment, the first device 102 (see FIG. 1) can determine an identity of an auditor or person 256 at a second communication device 104 and indicate, in any manner, at the first communication device the identity of one or more persons 258 at the second communication device in accordance with identity determining module 134. For example, were the device 104 to be lost and then found by someone other than its user, an otherwise confidential conversation may take place between the user of the first device 102 and the wrong person at the second device 104, compromising privacy. In accordance with the above-described embodiment, privacy implications due to the mobility of the device may be avoided.

It is understood that any manner including signal processing may determine the identity of an auditor or person. For example, in one embodiment, capturing a facial image of the auditor and processing the facial image with facial recognition software may provide the identity of the auditor. In another embodiment, capturing an image of a fingerprint of the auditor and processing the image with fingerprint recognition software may provide the identity of the auditor. In still another embodiment, receiving an identity signal from an RFID tag and processing the identity signal may provide the identity. In another embodiment, the user at the second device can input a security code to the second device keypad or audible input to determine the identity of the user of the second device.

In still another embodiment, voice recognition of the party or parties at the second device 104 may be determined by the first device 102 (see FIG. 1). It is understood that any manner in which to determine identity of the auditor at the second device 102 and indicate the identity to the first device 102 in accordance with identity indication module 136 is within the scope of this discussion. In this manner, a user of the first device 102 may better maintain control over his or her communications with individuals at the second device, including those within range of the speakerphone.

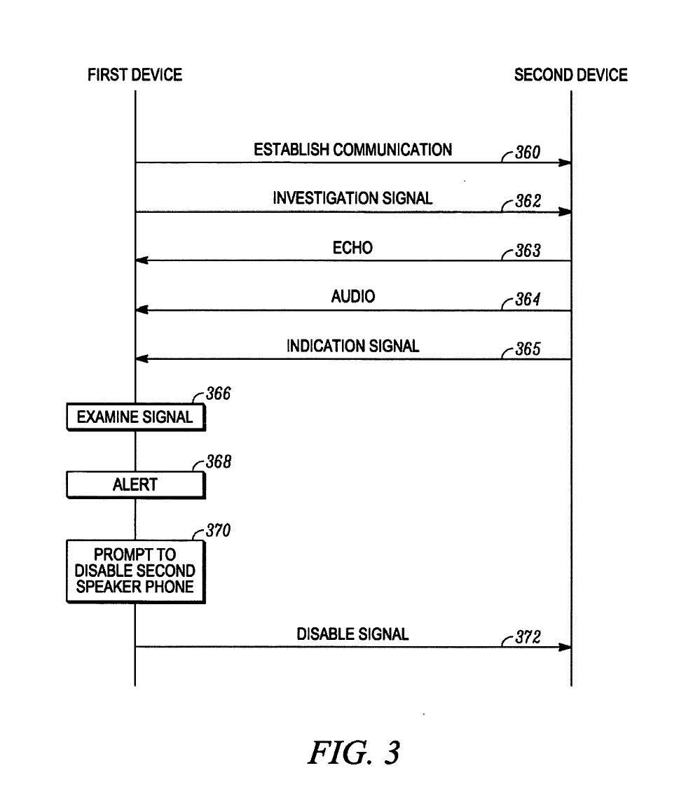

FIG. 3 is a signal flow diagram of an embodiment of the methods and devices as described above. In particular, FIG. 3 is a signal flow diagram showing that upon establishment of communication 360 that first communication device 102 (see FIG. 1) can determine if a speakerphone 102 of the second communication device 104 is active. An investigation signal 362 of any type can be used to make the determination. In one embodiment, the first device 102 can send an investigation signal resistant to a speakerphone echo cancellation mechanism to the second communication device 104 to determine whether an echo 363 from the signal is received at the first communication device.

In another embodiment, the first device can receive an audio signal 364 from the second communication device 104 (see FIG. 1) and process the audio signal to determine whether the audio signal includes characteristics of speakerphone use at the second communication device 104. In yet another embodiment, the first device can receive an indication signal 365 according to a protocol indicative of an active speakerphone at the second communication device either in response to an investigation signal or independent of an investigation signal. One or more of the described signals or other type of signal indicative of an active speakerphone of a second device 104 can be examined 366.

If it is determined that there is an active speakerphone 116 (see FIG. 1) at the second device 104 by the first device 102, the first device 102 can alert a user 368. Also, a user of the first communication device 102 may be prompted 370 as to whether to transmit a disable signal 372 to the second device 104 to disable the speakerphone. For example, a protocol to remotely disable speakerphones on the far side of a device can include dialing “*9” to disable and “*8” to release the speakerphone to the far end control.

The disclosed methods and devices for remote determination, control and/or inhibition of the use of a speakerphone of a far end telephone can provide an opportunity to control a remote speakerphone. The disclosed methods and devices for broadcast indication to inform proximal persons that a speakerphone is active and may reduce privacy for those proximal persons. The disclosed methods and devices to detect and/or report the identity of an auditor or user of a far end of a telephone communication may furthermore provide privacy to a user or users in communication with the far end device.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A method of a first communication device, the method comprising:
engaging in a communication with a second communication device;
determining at the first communication device if a speakerphone of the second communication device is active; and
alerting a user of the first communication device if a speakerphone of the second communication device is determined to be active.

2. The method of claim 1, wherein determining at the first communication device if a speakerphone of the second communication device is active comprises:
sending a signal resistant to a speakerphone echo cancellation mechanism to the second communication device; and
determining whether an echo from the signal is received at the first communication device.

3. The method of claim 1, wherein determining at the first communication device if a speakerphone of the second communication device is active comprises:
receiving an audio signal from the second communication device; and
processing the audio signal to determine whether the audio signal includes characteristics of speakerphone use at the second communication device.

4. The method of claim 1, wherein determining at the first communication device if a speakerphone of the second communication device is active comprises:
receiving at the first communication device a signal according to a protocol indicative of an active speakerphone at the second communication device.

5. The method of claim 1, further comprising:
annunciating, at the first communication device, the presence of an active speakerphone at the second communication device.

6. A method of a first communication device and a second communication device, the method comprising:
engaging by the first communication device in a communication with the second communication device;
determining if a speakerphone of the second communication device is active; and
prompting a user of the first communication device, if a speakerphone of the second communication device is determined to be active, whether to disable the speakerphone.

7. The method of claim 6, wherein determining if a speakerphone of the second communication device is active comprises:
sending a signal resistant to a speakerphone echo cancellation mechanism to the second communication device; and
determining whether an echo from the signal is received at the first communication device is indicative of an active speakerphone at the second communication device.

8. The method of claim 6, wherein determining if a speakerphone of the second communication device is active comprises:
receiving an audio signal from the second communication device; and
processing the audio signal to determine whether the audio signal includes characteristics of speakerphone use at the second communication device.

9. The method of claim 6, wherein determining if a speakerphone of the second communication device is active comprises:
receiving at the first communication device a signal according to a protocol indicative of an active speakerphone at the second communication device.

10. The method of claim 6, further comprising:
annunciating, at the first communication device, the presence of an active speakerphone at the second communication device.

11. The method of claim 6, further comprising:
sending by the first communication device to the second communication device a signal to disable the speakerphone of the second communication device.

12. The method of claim 6, further comprising:
determining an identity of an auditor at the second communication device; and
indicating at the first communication device the identity of an auditor at the second communication device.

13. A method of a first communication device having a speakerphone, the method comprising:
engaging in a communication with a second communication device;
determining if the speakerphone of the first communication device is active; and
broadcasting that the speakerphone of the first communication device is active when it is determined that the speakerphone of the first communication device is active.

14. The method of claim 13, wherein broadcasting comprises signaling nearby devices that a speakerphone is active.

15. The method of claim 13 wherein broadcasting comprises signaling the second communication device that a speakerphone is active.

16. The method of claim 13, wherein broadcasting comprises emitting a characteristic audible signal through the speakerphone.

17. A method of a first communication device, the method comprising:
determining an identity of one or more auditors at a second communication device; and
indicating at the first communication device the identity of an auditor at the second communication device.

18. The method of claim 16, wherein determining the identity of an auditor comprises:
capturing a facial image of the auditor; and
processing the facial image with facial recognition software.

19. The method of claim 16, wherein determining the identity of an auditor comprises:
capturing an image of a fingerprint of the auditor; and
processing the image with fingerprint recognition software.

20. The method of claim 16, wherein determining the identity of an auditor comprises:
receiving an identity signal from an RFID tag; and
processing the identity signal to determine the identity.
